(19) United States
(12) Patent Application Publication
(10) Pub. No.: US 2023/0136065 A1
(43) Pub. Date: May 4, 2023

(54) SILICON TIMEPIECE COMPONENT FOR A TIMEPIECE

(71) Applicant: ROLEX SA, Geneva (CH)

(72) Inventors: Jean-Luc Bucaille, Présilly (FR); Olivier Hunziker, Vevey (CH); Frédéric Kohler, Avry-sur-Matran (CH)

(73) Assignee: ROLEX SA, Geneva (CH)

(21) Appl. No.: 17/800,467

(22) PCT Filed: Feb. 18, 2021
(86) PCT No.: PCT/EP2021/053950

§ 371 Date: Aug. 17, 2022

(30) Foreign Application Priority Data
Feb. 25, 2020 (EP) 20159258.1

(51) Int. Cl. G04B 17/22; G04B 17/06; G04B 17/04; G04B 31/06

(52) U.S. Cl. CPC G04B 17/227; G04B 17/066; G04B 17/045; G04B 31/06

(57) ABSTRACT

The method for manufacturing a timepiece component is capable of thermocompensating a functional assembly including the timepiece component. The method includes at least the following actions: a) providing (e1) a substrate (1) of semiconductor or metallic material; b) proceeding with the deposition (e2) of a polycrystalline or monocrystalline silicon layer (5) on the substrate (1); c) releasing (e4) the timepiece component (10) from the substrate (1).

The invention relates to a process for manufacturing a timepiece component, notably a hairspring for an oscillator. It also relates to a timepiece component as such, and to a timepiece movement and a timepiece as such which comprise such a timepiece component.

These days, the manufacture of a timepiece component is very demanding since a timepiece component must provide numerous properties, including being preferably a magnetic, being provided with reliable mechanical properties that perform well, that endure over time, that are independent of external conditions and notably the temperature, while still being as simple as possible to manufacture so as to allow it to be utilized commercially. The existing solutions often rely on compromises and the resulting components are not optimized in performance terms. Moreover, the processes for manufacturing the timepiece components are often very complex to implement.

By way of example, the existing situation for mechanical watch oscillators will be described in detail. Similar conclusions will apply to other timepiece components.

The regulation of mechanical watches relies on at least one mechanical oscillator, which generally comprises a flywheel, referred to as balance, and a spring wound in the shape of a spiral, referred to as balance spring or more simply hairspring. The hairspring may be fastened at one end to the balance staff and at the other end to a fixed portion of the timepiece, such as a bridge, referred to as balance cock, on which the balance staff pivots. The balance spring with which the movements of mechanical watches of the prior art are equipped is in the form of an elastic metal strip or a silicon strip with a rectangular cross section, most of which is wound on itself in an Archimedes spiral. The balance/hairspring combination oscillates about its position of equilibrium (or dead center). When the balance leaves this position, it primes the hairspring. This creates a return torque that acts on the balance with a tendency to make it go back to its position of equilibrium. As it has picked up a certain speed, and therefore kinetic energy, the balance moves beyond its dead center until a counteracting torque of the hairspring stops it and forces it to turn in the other direction. In this way, the hairspring regulates the oscillation period of the balance.

It is known that, when the temperature varies, thermal expansions of the hairspring and of the balance, and the variation in the Young's modulus of the hairspring, modify the natural frequency of this oscillating assembly, thus disrupting the precision of the watch. There are prior art solutions which attempt to reduce, or even eliminate, instances of the frequency of an oscillator varying with the temperature. To that end, various prior art solutions seek to make the value of the coefficient of thermal expansion CT of the oscillator zero by choosing thermal properties of the hairspring that will be offset by those of the connected balance, in order to form an oscillator that is generally insensitive to the temperature variations.

By way of example, document EP1422436 describes a solution relying on a silicon hairspring comprising a silicon dioxide layer intended to thermally compensate an oscillator. This solution requires a thick oxide layer. Its manufacture requires subjecting the hairspring to treatment for a long period of time at a very high temperature, this representing a drawback. As a variant, document EP3159746 proposes the use of a heavily doped silicon. However, it is difficult to reach the high levels of doping necessary for thermal compensation.

In addition, the precision of mechanical watches also depends on the stability over time of the natural frequency of the oscillator formed by the balance and the hairspring. The existence of frequency drift phenomena of a balance/hairspring oscillator as a function of time is well known to timepiece manufacturers. Thus, for example, an oscillator equipped with a hairspring made of a ferromagnetic alloy as manufactured may gradually undergo an increase in its frequency to reach a running variation of the order of 10 s/day after one year. In order to reduce this drift, heat treatments are usually performed, referred to as baking treatments, which make it possible to reduce the running drift in the course of the first years to below 1 s/day, which is acceptable, given the other disruptions caused by wearing the watch, such as impacts.

Of course, a ferromagnetic alloy is also liable to be adversely affected by external magnetic influences which can manifest in an operating drift.

Lastly, it can be noted more generally that an existing timepiece oscillator hairspring, like any other timepiece component, has drawbacks that do not make it possible to achieve optimized operation of a timepiece.

The aim of the invention is to provide a new solution for a timepiece component, notably a balance spring, which makes it possible to optimize it while achieving both optimum performance, suitable for thermal compensation of a functional assembly, and sufficiently simple and robust manufacture.

More specifically, the invention seeks a solution for large-scale manufacture of a timepiece component with optimized performance, that is to say that its intrinsic mechanical properties ensure good operating performance while still being as stable as possible and remaining insensitive or not very sensitive to external attacks such as magnetic fields and temperature variations.

To that end, the invention relies on a process for manufacturing a timepiece component which is able to thermally compensate a functional assembly comprising the timepiece component, wherein it comprises at least the following steps:
a. providing a substrate made of semiconductor material or metal material;
b. carrying out the deposition of a polycrystalline- or monocrystalline-silicon layer onto the substrate;
c. releasing the timepiece component from the substrate.

The invention also concerns a timepiece component for a timepiece which is completely or partially made of polycrystalline silicon, wherein it comprises a portion made of polycrystalline silicon that is uniformly doped over its entire thickness, or wherein it comprises a portion made of polycrystalline silicon comprising a surface-doped layer.

The invention also concerns an oscillator for a timepiece and a timepiece as such.

The invention is defined more specifically by the claims.

These subjects, features and advantages of the present invention will be set out in detail in the following nonlimiting description of a particular embodiment in relation to the appended figures, in which:

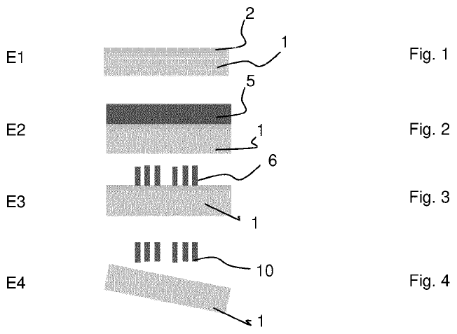

FIGS. 1 to 4 schematically show steps of a process for manufacturing a timepiece component according to one embodiment of the invention.

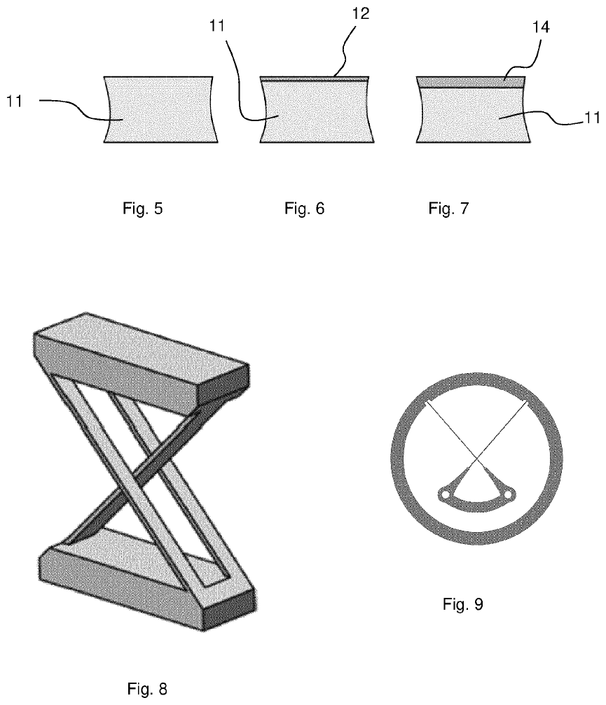

FIGS. 5 to 7 schematically show a technique that can be utilized for an additional doping step in a variant embodiment of the process for manufacturing a timepiece component according to the embodiment of the invention.

FIGS. 8 and 9 show various possible embodiments of timepiece components according to the embodiment of the invention.

The invention will be described in the context of a hairspring for a balance/hairspring assembly forming an oscillator for a timepiece. In this example, the hairspring is in the form of an elastic strip with a rectangular cross section, wound on itself in an Archimedes spiral. As a variant, the hairspring could have another basic geometry, like a non-rectangular cross section, which is constant or otherwise over the length of the hairspring. The invention will of course be transposable to the manufacture of timepiece components other than a hairspring, including a component of an oscillator with flexible guidance or a component of an arrangement of flexible geometries forming an elastic virtual pivot.

The balance, which is not shown, that is connected to the hairspring may be made from a copper/beryllium alloy, in a known manner. As a variant, other materials may be used for the balance. The invention according to this embodiment does not concern this balance as such. However, the hairspring is designed with a view to being able to thermally compensate the functional assembly forming an oscillator, composed of the combination of the hairspring with a certain given balance.

One embodiment of a process for manufacturing a hairspring for an oscillator of a timepiece movement will now be described in detail in relation to FIGS. 1 to 4.

This process comprises notably a first step E1 consisting in making available a substrate 1, which is a monocrystalline-silicon wafer in this embodiment. In this embodiment, a simple wafer is enough; it is not necessary to use a silicon on insulator (SOI) wafer, by contrast with most of the existing processes, although such a silicon on insulator wafer is still compatible with the invention. It is also not necessary to use a substrate made of a doped material. As a variant, the substrate may be metallic, or made of silicon carbide, or made of tungsten carbide, or made of quartz. A person skilled in the art will know to combine the substrate and the growth process such that the substrate is not modified by the process temperatures. They will also know to choose a substrate that is thick enough to allow it to be handled. Thus, a first advantage of the invention is to allow the use of a wafer, which is simpler and less expensive than substrates used in the prior art solutions, as substrate.

Advantageously, this first step E1 comprises optional additional steps of preparing the wafer. Thus, this wafer may be polished and cleaned. It may also be covered with an oxidation layer 2, as shown in FIG. 1. For example, its surface may be oxidized to form a surface layer, of the order of 2 μm thick, of silicon dioxide SiO₂.

As an alternative to the silicon substrate used in this embodiment, any other substrate made of semiconductor material and/or metal material, optionally coated with a layer of silicon dioxide SiO₂, may be used.

The process then comprises a second step E2, illustrated in FIG. 2, consisting in depositing a polycrystalline- or monocrystalline-silicon layer 5 at the surface of the substrate 1 (that is to say possibly onto the surface of the oxidation layer 2, if one is present).

According to a first approach, the polycrystalline or monocrystalline silicon may be deposited in a CVD reactor at high temperature with a gas flow containing silane and hydrogen. The growth is done epitaxially. In the case of a growth of polysilicon, the starting surface is formed from a layer of silicon which is already polycrystalline, such as those deposited in an LPCVD reactor at low temperature (seeding layer). This growth makes it possible to form a layer which rises in a direction perpendicular to the surface of the substrate 1.

As an alternative, it is possible to seed the silicon layer again during growth to maintain control over the features of the layer deposited in order to avoid excessively large grain sizes.

According to a second approach, polycrystalline silicon could be deposited by any other process.

Lastly, the deposition of silicon may consist in deposition of silicon by a CVD (“chemical vapor deposition”) process or PVD (“physical vapor deposition”) process.

The deposition of silicon is continued until a height of approximately 120 μm is reached, which will determine the thickness of the future timepiece component, as will be specified. It should be noted that it is possible to choose any other height, but advantageously a height of at least 80 μm, or even at least 100 μm, for the silicon layer. In all these cases, a thick layer is therefore involved.

At the end of this step, an optional intermediate step is advantageously implemented, consisting in polishing the silicon layer 5 thus formed, to ensure a satisfactory finish of its upper surface and a uniform height of the layer. This polishing may be of the type referred to as CMP (“chemical mechanical polishing”).

The process therefore implements a third step E3 of etching the silicon layer 5, the result of which is illustrated in FIG. 3. An etched layer 6 made of silicon is thus obtained. This etching is implemented by known methods, such as for example by deep reactive ion etching (DRIE). Such a method makes use of a resin that forms a mask, making it possible to delimit the zones to be etched in a predefined pattern, corresponding to the timepiece component (the hairspring) to be manufactured in this embodiment, before the resin is ultimately removed. This method is well known and will not be described in detail. As a variant, this etching may be carried out using a laser or by any other method known from the prior art. The result of this step is an etched layer 6 made of silicon arranged on the substrate 1.

Lastly, the process comprises a fourth step E4 of releasing the etched layer 6 made of silicon from the substrate 1, as illustrated in FIG. 4, which makes it possible to obtain the timepiece component 10. It should be noted that the substrate 1 is therefore used only to manufacture the timepiece component and is not intended to be part of the timepiece component 10. The latter thus has a thickness corresponding to the height of the optionally treated silicon layer 5 formed by the silicon deposition step E2.

This process advantageously makes it possible to simultaneously manufacture multiple timepiece components on the same substrate 1. In such a case, the fourth, releasing step E4 consists in releasing all of these timepiece components. The releasing is carried out according to one of the techniques known from the prior art, for example by etching the substrate 1 via its bottom surface in order to create indentations facilitating access to the oxidation layer 2 so as to dissolve it using hydrofluoric acid or by perforating the non-etched portions of the upper portion of the SOI wafer.

It is important to note that the monocrystalline silicon exhibits anisotropy of its elastic properties since its modulus of elasticity depends on the crystal orientation.

This anisotropy of the modulus of elasticity was measured as being of the order of ±15% around its mean value. The effect of this technical feature is passed on in the form of constraints when a component made of monocrystalline silicon is being manufactured, since such a design must take into account this phenomenon in order to obtain a timepiece component with a performance that is not adversely affected or is only slightly adversely affected by this anisotropy. Thus, the variant embodiment making use of a polycrystalline silicon thus has the advantage of making it possible to obtain a timepiece component with isotropic elastic properties, thereby simplifying the overall design of the timepiece component, of the hairspring in this embodiment.

It should additionally be noted that the timepiece component 10 obtained by the embodiment results from a single silicon deposition step, thereby making it possible to obtain a timepiece component which is in one piece, homogeneous, monobloc, monolithic. It is not formed by joining multiple separate parts or by a succession of separately grown layers.

Further additionally, the timepiece component thus formed is intended for combination with one or more other components for the implementation of a certain timepiece functionality: this holds true when this timepiece component is a hairspring intended for combination with a balance so as to form an oscillator of a timepiece movement, as explained above. The two separate timepiece components, the hairspring and the balance, are thus intended to cooperate in order to provide their shared oscillator functionality. Thus, more generally, a given timepiece component is intended to be part of a more extensive functional assembly.

As was recalled above, another advantageous objective during the manufacture of a timepiece component is to seek for it to be minimally dependent on temperature variations, so as to achieve identical operation at all temperatures. Thus, the invention makes it possible to manufacture a timepiece component that contributes to the thermal compensation of this functional assembly.

To that end, it is known, in particular from document EP3159746, that heavily doping the silicon of a hairspring makes it possible to improve the performance of the oscillator obtained with respect to temperature variations. Specifically, it is noted that, depending on the material used for the balance, for example titanium or a titanium alloy, this heavily doped silicon of the hairspring alone may be enough to obtain thermal compensation of the oscillator resulting from the cooperation of the hairspring with the balance. By way of example, n-type doping of the silicon is obtained, for example, by using at least one element from among the following: antimony Sb, arsenic As, or phosphorus P. Doping is to be understood to mean one of the solutions mentioned above, or an equivalent solution. The invention has another advantage of facilitating the acquisition of a component made of doped silicon, as will be described in detail below.

According to a first variant embodiment, the silicon is doped in a manner referred to as “in situ”, that is to say directly during the silicon deposition step E2, at the same time as this deposition, notably with n-type dopants such as phosphorus. For this, it is possible to diffuse the dopant element at high temperature after depositing the element in the gas phase on the surface of the wafer, or to directly implant the ions via an ion beam. This first variant embodiment has the advantage of obtaining a timepiece component in which the silicon is doped over its entire thickness (over the entire height of the silicon layer 5 deposited). Such doping may also be substantially uniform, homogeneous, throughout the volume of the silicon.

According to a second variant embodiment, a doping step is implemented after the end of the step E2 of depositing the silicon layer 5. In such a case, the doping step may be implemented before or after etching of the silicon layer 5, in the case of the embodiment described above. It is preferably implemented before the step E4 of releasing the timepiece component, but in a variant, it could also be implemented after the releasing step E4, thus on the timepiece component separated from the substrate. Such a doping step is a diffusion or ion implantation doping step, making it possible for the dopant to diffuse into the timepiece component, forming a doped layer in a portion of the thickness of the timepiece component. Such doping does not give uniform doping in said doped layer, the doping becoming slighter with increasing distance from the surface through which the diffusion is performed. It is notable that such diffusion is faster in polycrystalline silicon than in monocrystalline silicon, by virtue of the presence of grain boundaries in the polycrystalline silicon.

To that end, FIGS. 5 to 7 illustrate a method for doping a component 11 made of silicon, shown in FIG. 5, that can be utilized for the second variant embodiment described above. This component 11 is first of all coated with a layer 12 of 110 nanometers of POCl3, as shown in FIG. 6. A first diffusion of phosphorus within the polycrystalline silicon is then performed via at least one annealing operation lasting 60 minutes under a nitrogen atmosphere (for example a first annealing operation lasting 60 minutes at 900° C., followed by another annealing operation lasting 60 minutes at 1000° C.). The POCl3 layer is then removed by immersion in buffered hydrofluoric acid. The result obtained is illustrated in FIG. 7. Such a method makes it possible to form a layer 14 doped to a high level, greater than or equal to 10²¹ at/cm³. A second assay of diffusing phosphorus into the polycrystalline silicon was carried out via an annealing operation lasting 4 hours. Thus, different implementation variants are possible, depending on the desired result. As an alternative, it is possible to dope the polycrystalline silicon by means of a 200 nm deposition of PSG (phosphosilicate glass) deposited at the surface of the polycrystalline silicon and followed by a heat treatment lasting one hour at 1050° C. under an argon atmosphere, and then removing the PSG layer by a RIE method. This PSG layer may likewise serve as a mask for the polysilicon etching step.

Of course, the two doping variants described above may be combined, a doping operation a posteriori thus supplementing a first doping operation carried out in situ during the growth of the polycrystalline-silicon layer.

It has been noted that doping a monocrystalline silicon causes significant anisotropy of its coefficient of thermal expansion (CTE), which was essentially isotropic before the doping. This is why, when producing a hairspring made of doped monocrystalline silicon, it is thus often recommended to vary the thickness of the turns of the hairspring over its length in order to compensate the variations of said coefficient of thermal expansion.

A timepiece component made of doped polycrystalline silicon has the advantage of preserving an isotropic coefficient of thermal expansion (CTE), thereby rendering the design of a timepiece component less constrained. Specifically, implementing the invention with polycrystalline silicon has the advantage of great freedom in the design of a timepiece component, while still being able to achieve significant insensitivity to temperature variations. In addition, it must be emphasized that it has proven easier to dope the polycrystalline silicon than the monocrystalline silicon.

It should be noted that the doping methods described above are compatible with different levels of doping of the silicon, even high levels making it possible to achieve thermal compensation of a timepiece component, like an oscillator. For example, a heavily doped silicon may be used. Heavily doped is to be understood to mean that the silicon is doped with an ion density greater than or equal to 10¹⁸ at/cm³, or even greater than or equal to 10¹⁹ at/cm³, or even greater than or equal to 10²⁰ at/cm³.

However, it is still possible to choose lower levels of doping in order to simplify or accelerate the doping, for example, while still supplementing the process by forming a surface layer of silicon oxide SiO2, as described in EP1422436, which also additionally contributes to the thermal compensation function. As a variant, it is possible for this silicon oxide layer not to be an external layer, but for example an internal layer, for example sandwiched in the structure of the component. Thus, the timepiece component may more generally comprise a portion made of silicon oxide. Carrying out doping has the advantage, in all cases, of making it possible to reduce the oxide layer or portion that would be necessary in a solution without doping.

Thus, as mentioned above, the process may optionally comprise an additional oxidation step. As explained, the oxidation layer or portion used may have a small thickness, thereby having the advantage of making it possible to produce it at a lower oxidation temperature. Moreover, this small thickness of the oxidation layer or portion also makes it possible to produce it using oxygen as a precursor, instead of the water vapor used for thicker oxidation layers, thus making it possible to form a high-quality oxidation layer or portion while still minimizing its growth time.

Thus, it becomes apparent from the variants described above that the invention makes it possible to advantageously obtain a value of the coefficient of thermal expansion (CTE) of zero for a balance/hairspring combination, the oscillations of which thus become independent or virtually independent of the temperature. In other words, the hairspring of the invention makes it possible to be adapted for making the coefficient of thermal expansion (CTE) of a balance/hairspring oscillator forming a functional assembly zero.

In summary, the process for manufacturing a timepiece component of the invention is simplified and less expensive than existing procedures, as described above, while still offering great flexibility since multiple implementation variants make it possible to greatly and simply improve the performance of the timepiece component, notably by making it possible to address the problem of thermal compensation. This is because the process of the invention proposes the manufacture of a timepiece component able to thermally compensate a larger functional assembly comprising multiple components including said timepiece component, these multiple components together performing a certain timepiece functionality, such as that of an oscillator, as described above.

The process of the invention is still compatible with other treatments known from the prior art. For example, a finishing step may consist in smoothing the surface of the silicon, as described in document EP2277822. Said document describes the performance of a step of forming an oxide layer and then dissolving it, making it possible to remove the surface layer of the silicon, which runs the risk of having defects and/or forming cracks. Such a step thus makes it possible to round off rough areas and to reinforce the component. This solution lastly consists in smoothing the surface of the polycrystalline silicon.

The invention also concerns a polycrystalline-silicon timepiece component obtained by the process described above. Such a component advantageously comprises a monobloc, one-piece, integral portion originating from a single polycrystalline-silicon growth step. It may also comprise doping, possibly heavily doping, the polycrystalline silicon.

The invention is particularly suitable for forming a hairspring, as described above, but also other timepiece components illustrated in FIGS. 8 and 9, such as a component of an oscillator with flexible guidance, a component of an arrangement of flexible geometries forming an elastic virtual pivot.

The invention also concerns a timepiece oscillator, a timepiece movement, and a timepiece, such as a watch, for example a wristwatch, comprising at least one timepiece component as described above.

1. A process for manufacturing a timepiece component which is able to thermally compensate a functional assembly comprising the timepiece component, wherein the process comprises:
providing a substrate made of semiconductor material or metal material;
carrying out a deposition of a polycrystalline- or monocrystalline-silicon layer onto the substrate;
releasing the timepiece component from the substrate.

2. The process for manufacturing a timepiece component as claimed in claim 1, wherein the process additionally comprises forming an oxide layer a surface of the substrate before depositing the silicon layer.

3. The process for manufacturing a timepiece component as claimed in claim 1, wherein the process comprises etching the silicon layer before releasing the time piece component.

4. The process for manufacturing a timepiece component as claimed in claim 1, wherein the process comprises polishing before etching the timepiece component.

5. The process for manufacturing a timepiece component as claimed in claim 1, wherein the deposition of the silicon layer is continued until a height of greater than or equal to 80 μm is reached.

6. The process for manufacturing a timepiece component as claimed in claim 1, wherein the deposition of the silicon layer includes depositing silicon by CVD.

7. The process for manufacturing a timepiece component as claimed in claim 1, wherein the deposition of the silicon layer incudes depositing silicon by PVD.

8. The process for manufacturing a timepiece component as claimed in claim 1, wherein the deposition of the silicon layer comprises simultaneous doping, making it possible to grow a doped-silicon layer.

9. The process for manufacturing a timepiece component as claimed in claim 1, wherein the process comprises doping silicon of the silicon layer after the deposition or after the etching, by diffusion or ionic implantation of a dopant.

10. The process for manufacturing a timepiece component as claimed in claim 8, wherein the process comprises doping the silicon using a dopant selected from the group consisting of antimony Sb, arsenic As, and phosphorus P.

11. The process for manufacturing a timepiece component as claimed in claim 8, wherein the process comprises all or part of a volume of silicon in heavily doped silicon with an ion density of greater than or equal to 10¹⁸ at/cm³.

12. The process for manufacturing a timepiece component as claimed in claim 1, wherein the process additionally comprises smoothing the timepiece component or adjusting dimensions of the timepiece component, by a succession of oxidations and oxide dissolutions.

13. The process for manufacturing a timepiece component as claimed in claim 1, wherein the process additionally comprises oxidizing at least one surface of the timepiece component.

14. The process for manufacturing a timepiece component as claimed in claim 1, wherein the substrate is made of monocrystalline silicon.

15. The process for manufacturing a timepiece component as claimed in claim 1, wherein the process makes it possible to manufacture an oscillator hairspring or an arrangement of flexible geometries forming an elastic virtual pivot.

16. A timepiece component for a timepiece which is completely or partially made of polycrystalline silicon, wherein the timepiece component comprises a portion made of polycrystalline silicon uniformly doped over its entire thickness, or wherein the timepiece component comprises a portion made of polycrystalline silicon comprising a surface-doped layer.

17. The timepiece component for a timepiece as claimed in claim 16, wherein timepiece component comprises a heavily doped polycrystalline silicon with an ion density of greater than or equal to 10¹⁸ at/cm³, in order to allow thermal compensation of a functional assembly in which the timepiece component is intended to be arranged.

18. The timepiece component for a timepiece as claimed in claim 16, wherein the timepiece component is a hairspring for an oscillator or a component of an arrangement of flexible geometries forming an elastic virtual pivot, or a component of an oscillator with flexible guidance.

19. The timepiece component for a timepiece as claimed in claim 16, wherein the timepiece component comprises a layer or portion made of silicon dioxide SiO₂.

20. An oscillator for a timepiece, wherein the oscillator comprises the timepiece component as claimed in claim 16 and a balance, wherein the timepiece component is a hairspring, and wherein the oscillator is thermally compensated.

21. The oscillator for a timepiece, wherein the oscillator comprises the timepiece component as claimed in claim 16, wherein the timepiece component has flexible guidance, and wherein the oscillator is thermally compensated.

22. A timepiece comprising the timepiece component as claimed in claim 16.
